(19) United States
(12) Patent Application Publication
(10) Pub. No.: US 2013/0290122 A1
(43) Pub. Date: Oct. 31, 2013

(54) EXTENDED KEYPAD FOR CONTROLLING VENDING MACHINE OPERATION

(71) Applicants: William C. Royal, Jr., Oak Ridge, NC (US); Ignacio Santa Cruz, St. Louis, MO (US); Viktor Partyshev, Kiev (UA); Troy Doom, North Augusta, SC (US)

(72) Inventors: William C. Royal, Jr., Oak Ridge, NC (US); Ignacio Santa Cruz, St. Louis, MO (US); Viktor Partyshev, Kiev (UA); Troy Doom, North Augusta, SC (US)

(73) Assignee: CRANE MERCHANDISING SYSTEMS, INC., Bridgeton, MO (US)

(21) Appl. No.: 13/871,538

(22) Filed: Apr. 26, 2013

Related U.S. Application Data
(60) Provisional application No. 61/638,910, filed on Apr. 26, 2012.

(51) Int. Cl. G06Q 20/20

(52) U.S. Cl. CPC G06Q 20/20
USPC 705/25

(57) ABSTRACT

A user selection keypad allows at least some functionality of vending machine programming configured for a touchscreen display to be utilized without the touchscreen. In addition to character-labeled keys and other standard functionality (such as keys to confirm or cancel an entry), the keypad includes: a shopping cart key that, when actuated, invokes aggregation of multiple product selections for a single vend transaction; and an information key that, when actuated, allows the customer to request display of nutritional information for a currently selected product and/or context-sensitive help information.

### CROSS-REFERENCE TO RELATED APPLICATIONS

This application incorporates by reference U.S. Provisional Patent Application No. 61,638,910 entitled “EXTENDED KEYPAD FOR CONTROLLING VENDING MACHINE OPERATION” and filed on Apr. 26, 2012.

### TECHNICAL FIELD

The present application relates generally to the customer user interface in vending machines and, more specifically, to the modification of the user interface to support functionality across multiple customer selection interface designs.

### BACKGROUND

Vending machines offer unattended sales of commodities such as snacks, canned or bottled beverages, or any of a variety of other articles. Traditionally the user interface for vending machines has included a keypad in which the customer entered a product selection identifier during a vend transaction, typically by pressing a combination of keys corresponding to one alphabetic character and one numeric character (e.g., “A3” or “C7”). More recently, use of touchscreen user interfaces have become more prevalent in vending machines, offering greater flexibility in the vend transaction process. For example, product selection with a touchscreen user interface may involve selection from among a group of displayed product categories (e.g., soft drink, candy, chips, etc.) to cause display of the individual products within a particular category available for purchase.

### SUMMARY

A user selection keypad allows at least some functionality of vending machine programming configured for a touchscreen display to be utilized without the touchscreen. A user selection keypad includes character-labeled keys, keys to confirm or cancel an entry, the keypad includes: a shopping cart key that, upon actuation, invokes aggregation of multiple product selections for a single vend transaction; and an information key that, upon actuation, allows the customer to request display of nutritional information for a currently selected product or context-sensitive help information.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified perspective view illustrating a vending machine implementing an improved user interface keypad according to embodiments of the present disclosure;

FIG. 2 is a block diagram of a control system within a vending machine utilizing an improved user interface keypad according to embodiments of the present disclosure;

FIG. 3 illustrates an improved user interface keypad according to embodiments of the present disclosure; and

FIGS. 4A, 4B and 4C are high level flow diagrams for a portion of a process during a vend transaction in which actuation of an extended key is detected within an improved user interface keypad according to embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### DETAILED DESCRIPTION

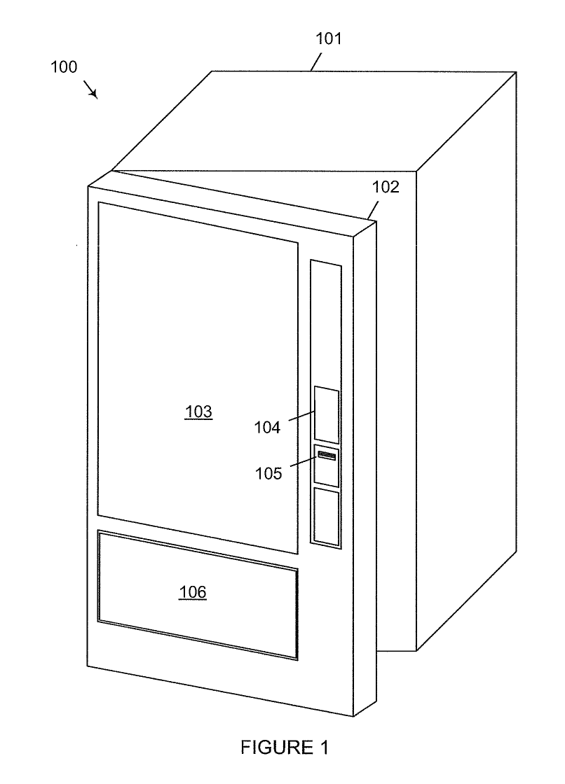

FIGS. 1 through 4C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine currency handling system.

Although a touchscreen user interface provides increased flexibility in the vend transaction process, such devices significantly increase the overall cost of a vending machine and are more susceptible to inadvertent or malicious damage. Nonetheless, in an overall vending machine design configured to operate without a touchscreen user interface, it would be advantageous to still exploit some of the expanded functionality programmed into the vending machine based on the potential availability of a touchscreen device. Conventional vending machine keypads having a limited number of alphabetic and numeric keys do not intuitively support such functionality. There is, therefore, a need in the art for an improved customer user interface for vending machines.

According to embodiments of the present disclosure, a user selection keypad allows at least some functionality of vending machine programming configured for a touchscreen display to be utilized without the touchscreen.

FIG. 1 is a simplified perspective view illustrating a vending machine implementing an improved user interface keypad according to one embodiment of the present disclosure. Vending machine 100 includes a cabinet 101 and a service door 102 that, together, define an enclosure. In the embodiment illustrated, the service door 102 is pivotally mounted to the front of the cabinet 101 and extends all the way across the front face of the vending machine 100. In alternate designs, the service door may extend only part way across the front of the vending machine, or may be formed in two portions (of equal or unequal sizes) that swing open in opposite directions.

In the embodiment illustrated in FIG. 1, the service door 102 includes a transparent front 103 allowing the customer to view actual products available for vending, which may include snacks, packaged beverages, or both.

Vending machine 100 also includes a customer product selection interface 104, payment mechanism access 105 and a delivery bin door 106. Customer product selection interface 104, which could be a touch-screen liquid crystal display (LCD) display and input, is instead in the present disclosure an alternate extended keypad design compatible with expanded vend transaction processing, as described in further detail below.

Payment mechanism access 105 may include one or more of a coin slot allowing deposit of coins into a coin mechanism, a bill access slot for feeding paper currency into a bill validator and/or recycler, and a magnetic stripe swipe mechanism for reading the magnetic stripe on credit or debit cards.

The vending machine 100 includes a delivery bin door 106 positioned below the transparent window 103 and substantially across the width of the product columns behind the transparent window. Products available for vending are thus held in, for example, helical coils on shelves visible from the exterior through the transparent window 103 and are dropped through a space between the shelves and the transparent window 103 into the delivery bin behind delivery bin door 106. Those skilled in the art will recognize that in some vending machines, particularly beverage vending machines, an X-Y product retrieval and delivery mechanism delivers vended product to an access port to the side as shown in FIG. 1, at a height convenient to the customer for product retrieval without bending over.

Those skilled in the art will recognize that the complete structure of a vending machine is not depicted in the drawings, and the complete details of the structure and operation of the vending machine is not described herein. Instead, for simplicity and clarity, only so much of the structure and operation of a vending machine as is unique to the present disclosure or necessary for an understanding of the present invention is depicted and described.

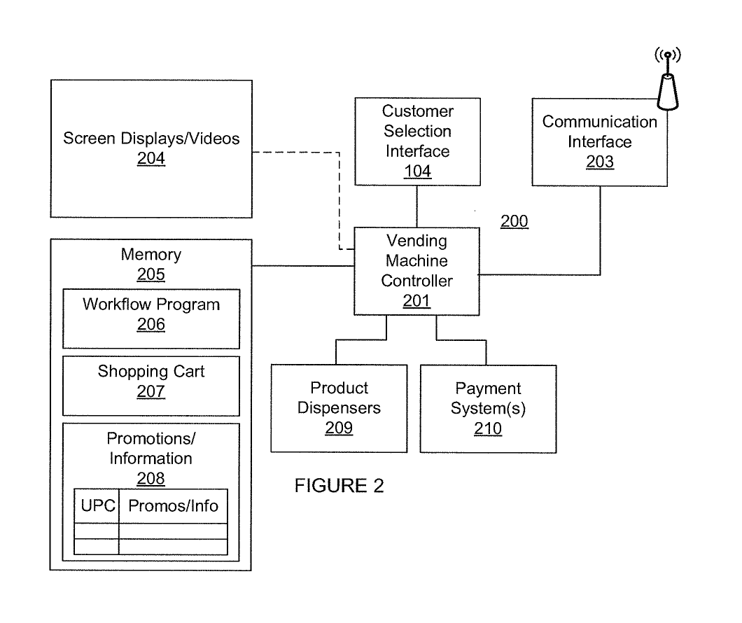

FIG. 2 is a block diagram of a control system 200 within a vending machine 100 utilizing an improved user interface keypad according to embodiments of the present disclosure. Although certain details will be provided with reference to the components of the control system 200 of FIG. 2, it should be understood that other embodiments may include more, less, or different components.

The control system 200 includes a programmable vending machine controller (“VMC”) 201, an extended keypad 104, a communication interface 203 and one or more memories 205. The VMC 201 is coupled to and communicates with the extended keypad 104, which detects customer contact with the keys of that keypad, such as by detecting a physical contact by a human or by detecting pressure. During a vend transaction and between transactions, a display controller (which may be integral to VMC 201 or which may be a separate controller, not shown) generates content for display.

The VMC 201 is coupled to and communicates with communication interface 203. The communication interface 203 enables the control system 200 to transfer data to external devices, such as a handheld computer, a network operations center, or another vending machine. Communication may be by wireless data transfer, local area network Internet communication, or through an access port provided in the vending machine 100, such as Universal Serial Bus (“USB”). Communication with devices external to the vending machine 100 allows the for update of the programming of the vending machine 100, for transfer of data including operational data such as sales, remaining inventory or the operational status of various subsystems, for update of pricing or other information used by the vending machine 100 during a vend transaction, and allows for the coordinated and common operation of multiple vending machines.

The VMC 201 also is coupled to or includes a memory 205. While shown as separate from VMC 201, memory 205 may be implemented within the same integrated circuit as VMC 201. In addition, memory 205 may be included within a single memory unit, but provide partitioned sectors within that single memory unit. The memory 205 may include any suitable volatile and/or non-volatile storage and retrieval device(s). For example, the memory 205 can include any electronic, magnetic, electromagnetic, optical, electro-optical, electro-mechanical, and/or other physical device(s) that can contain, store, communicate, propagate, or transmit information. The memory 205 can store data and instructions for use by the VMC 201. Additionally, the memory 225 can store information related to the vend transactions that the VMC 201 performs, such as product information, promotion information, product inventory, co-located vending machine status, event history, maintenance history, and so forth. Memory 205 stores the workflow program 206 used to control the vending machine's operations during a vend transaction, a “shopping cart” data structure 207 that holds identifiers for product selections (e.g., the product's Universal Product Code (“UPC Code”)) during the vend transaction, and optionally, a table 208 of promotions or information relating to products available for vending from the vending machine. In one example of table 208, the promotions are associated with and organized by the UPC Code for product selections.

The VMC 201 is coupled to and communicates with one or more product dispensers 209 (e.g., helical coils or an X-Y product retrieval mechanism) and payment system 210. Payment system 210 is optionally coupled to the communication interface 203. The communications interface 203 enables communication between the payment system 210 and an external facility, such as an account server, bank or credit card authorization center. The payment system 210 may include a coin mechanism, a bill validator/recycler, a magnetic stripe card reader, a cashless payment device reader (e.g., reader of fobs, tags, tokens, and screen of user devices), or any combination thereof. The VMC 201 receives signals from and controls the operation of product dispensers 209 and payment system 210.

Those skilled in the art will recognize that the complete structure and operation of the control system 200 is not shown or described herein. Instead, for simplicity and clarity, only so much of the complete structure and operation of the control system 200 as is unique to the present disclosure or necessary for an understanding of the present disclosure is shown and described.

The control system 200 is configured to enable the vending machine 100 to provide an improved user interface keypad. The VMC 201 is typically implemented using a programmable microcontroller mounted on a printed circuit board (PCB) with suitable connections to a Multi-Drop Bus (MDB) for peripherals. Coupled to VMC 201 is a display (not shown), such as an array of eight-segment light emitting diode (LED) character displays or a graphical (non-touchscreen) display. The VMC 201 causes the display to show a menu incorporating the products offered for sale within the vending machine 100.

In performing a vend transaction, the VMC 201 executes instructions within the workflow program 206. The VMC 201 sends information to be stored in the memory 205. In certain embodiments, the program 206 is configured to operate with either an LCD touchscreen display or with the customer selection interface 104 described in further detail below. That is, the program 206 includes instructions that cause the VMC 201 to send and receive signals corresponding to either the touchscreen display or the customer selection interface 104, depending on what connections are detected and/or on a selective configuration of an attribute of the program 206 by the operator.

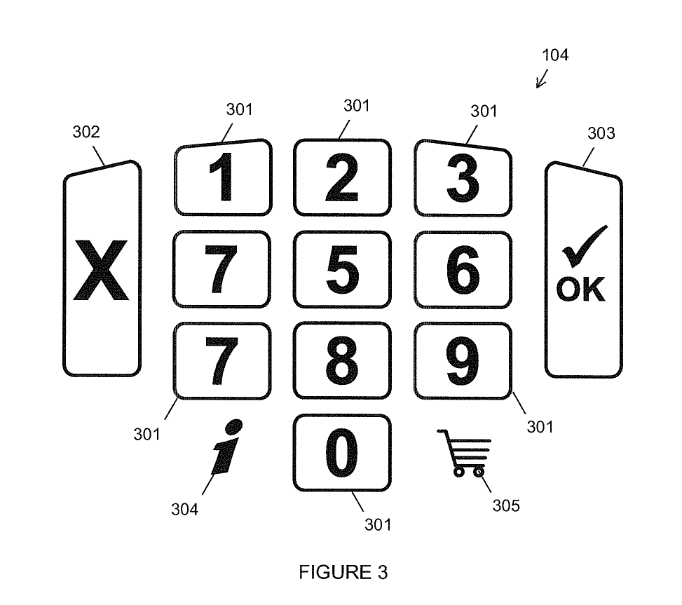

FIG. 3 illustrates an improved or extended user interface keypad 104 according to embodiments of the present disclosure. The keypad depicted is implemented as part of the customer selection interface 104 utilized by the customer to enter product selections into the vending machine. That is, a customer presses buttons on the keypad to input a customer selection. The, in response to receiving the input, the keypad sends signals corresponding to the customer selections to the VMC 201. The keypad in the example depicted does not include separate raised square keys as might be found on a computer keyboard, but instead has keys defined by delineated regions on a generally smooth or continuous surface area. In certain embodiments, the keypad includes separate raised square keys as might be found on a computer keyboard. The customer selection interface 104 includes backlighting to illuminate either the entire keypad or selective regions, such as illumination of individual keys when pressed to provide the user with confirmation that actuation of the key has been detected.

The areas of the keypad design/layout depicted are designed with a particular purpose (including the use of specific colors for the “X” and “OK” buttons described below), with an overall design laid out to facilitate a general left-to-right flow. The keypad includes ten keys 301 with numeric labels “0” through “9,” for entry of a product selection or to select one of a menu of alternatives displayed to the customer on the display. For example, a product selection includes a location code numerically indicating the row and column location of the product to be purchased (“10,” “25,” “33,” etc.). Also for example, the menu of alternatives includes a menu code indicating a group of products to be jointly purchased. A menu code is different from all location codes to avoid customer confusion. In addition, the keypad includes keys 302 and 303 allowing a user to either cancel or confirm, respectively, a current selection, with intuitive labels such as the large red “X” cancel button 302 and the green checkmark and “OK” confirm button 303 depicted in FIG. 3.

In the example shown, the keypad also includes two additional keys for customer interaction with the vending machine, and particularly to enhance the vend transaction process flow. A discrete “shopping cart” button 305 has a primary purpose of enabling the customer to “add” items to a virtual shopping cart for a multi-vend transaction, in which the customer makes multiple purchases by entering all product selections, pays the aggregate cost of such purposes in a single payment, and receives delivery of all purchased products (most likely delivered in succession) upon confirmation of the payment. Button 305, shown labeled with a stylized but familiar icon for a shopping cart to communicate the function, thus allows the customer to aggregate product selections for a single vend transaction.

Button 305 is also used, within program 206, to allow the customer to select promotional offers displayed on the display, particularly when the promotion will involve adding items to the shopping cart. Thus, for instance, if the customer selects a bag of potato chips and the program 206 is configured to offer the customer a soft drink of a specific brand at a discounted incremental cost (say, $0.75 instead of $1.50), actuation of button 305 will be interpreted by program 206 as acceptance of that offer by the customer.

A second additional special purpose information (“info” or “i”) key or button 304 is included in the keypad. One function of button 304 is to allow the customer to request display of nutritional information (when available within table 208 for a given product, as indexed by the product's UPC code) for a selected product to be displayed on the display. When no nutritional information is available for the currently selected product, a message to that effect may be displayed instead. In addition, an alternative function of button 304 is to enable the user to request display of context-sensitive help or other information at any point during a vend transaction. Thus, for instance, if the user is uncertain about how to select an additional product or how to make payment, actuation of “info” button 304 may result in program 206 display instructions for operation of the shopping cart function or one or more of the payment systems, as appropriate.

As with the remaining buttons on the keypad design depicted, buttons 304 and 305 may be illuminated when active, and may also be made to blink/flash to draw the consumer's attention. For example, if a particular phase of a given vend transaction has lasted too long without activity by the customer, the “info” button 304 may be made to flash to draw the customer's attention, signaling to the customer that help is available upon request by actuating button 304.

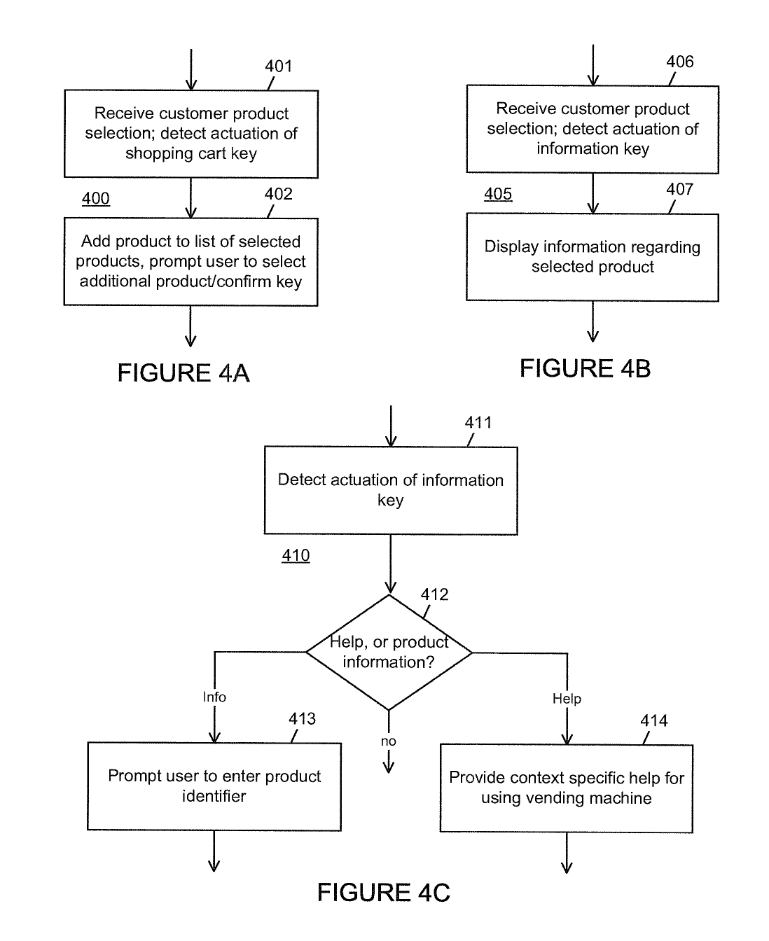

FIGS. 4A, 4B and 4C are high level flow diagrams each of a portion of process during a vend transaction in which actuation of an extended key is detected within an improved user interface keypad according to embodiments of the present disclosure. The exemplary processes depicted are executed within the vending machine 100, primarily by VMC 201 based on signals received from customer selection interface 104, and specifically based on signals from the extended keys 304 and 305 in the keypad of FIG. 3. In the exemplary process 400 of FIG. 4A, during a vend transaction, the VMC 201 has received a customer product selection, entered using the numeric keys 301, and detected actuation of the shopping cart key 305 (step 401). The customer has previously been prompted to enter a product selection and then actuate either the confirm key 303 or the shopping cart key 305. If the confirm key 303 had been actuated, the process would have simply proceeded to completing the vend transaction (e.g., prompting the user for payment, delivering the selected product, etc.).

In the example shown, however, the customer selected the shopping cart key 305. As a result, the most recently selected product is added to the list of selected products and the user is prompted to either select and additional product or actuate the confirm key (step 402). The list of selected products may contain only a single product identifier—i.e., that of the most recently selected product. Alternatively, the list may contain a number of product identifiers for previously selected products, up to a predefined limit (which may be specified in terms of either quantity or products or total price for all selected products).

When the shopping cart key 305 is actuated following a product selection, the customer is prompted to either select an additional product or actuate the confirm key 303. This allows the customer to change their mind about selecting an additional product, and complete the vend transaction with just the previously selected products. The process 400 then proceeds from step 402 to continue with the vend transaction.

Notably, if the shopping cart key 305 were actuated at a point during the vend transaction other than following entry of a product selection, alternative functionality might be initiated. For example, under such circumstances, the content of the shopping cart (including quantities, product identifiers, and total price) might be displayed.

FIG. 4B illustrates one exemplary process in which the information key 304 is actuated. In the exemplary process 405 depicted, during a vend transaction, the VMC 201 has received a customer product selection, entered using the numeric keys 301, and detected actuation of the information key 304 (step 406). The process then proceeds to display information regarding the just-selected product (step 407). The information displayed may be nutritional information and/or information selected for presentation by the product manufacturer. Depending on the type of display, the information may be presented to the user as a single display (on a non-touchscreen graphical display, for example) for either a predetermined period of time or until another key is actuated by the user, or may be scrolled for the user (on an eight segment display, for example).

FIG. 4C illustrates an exemplary process 410 in which the information key 304 is actuated by the customer at a point during a vend transaction not immediately following selection of a product (e.g., prior to selecting any products, after being prompted to enter payment, etc.). The process detects actuation of the information key (step 411), when product selection was not the most recent activity by the customer. The user is prompted to determine whether help is being requested, or product information (step 412). This allows customers to obtain product information without first selecting a product for purchase. If the customer indicates (by actuation of a predetermined and specified one of the numeric keys, for example) that information is desired, the customer is prompted to enter a product identifier using the numeric keys (step 413). If the customer indicates that help is needed, the VMC determines the current phase of the vend transaction and provides context specific help (step 414). For example, if the customer requested help upon being requested to enter payment, the VMC might cause the bezel of a payment device in the vending machine to flash, to attract the customer's attention, while again prompting the customer to enter payment. Alternatively, the help were requested upon entry of a product selection into the shopping cart but before receiving an indication that the customer desired to “check out,” instructions on which key to press to complete the vend transaction might be displayed (and illumination of the corresponding key flashed).

Although the present disclosure has been described with exemplary embodiments, various changes and modifications may be suggested to one skilled in the art. It is intended that the present disclosure encompass such changes and modifications as fall within the scope of the appended claims.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
storing a plurality of products;
displaying, by a non-touchscreen user interface display, a menu relating to vending of at least some of the plurality of products;
receiving inputs, by a user selection interface comprising a keypad, from a customer indicating a customer key selection of one or more of a plurality of keys within the keypad, wherein the keypad includes a plurality of numeric keys, a cancel key, a confirm key, and at least one of
an information key that, when actuated, requests either additional information regarding a selected product or assistance in completing a vending transaction, and
a shopping cart key that, when actuated, either enables selection of an additional product for a multi-vend transaction or accepts a promotional offer; and
sending signals corresponding to customer key selections to a vending machine controller.

2. The method of claim 1, wherein actuation of the shopping cart key is configured to trigger utilization of shopping cart functionality within transaction flow programming and to allow the customer to aggregate multiple product selections for a single vend transaction.

3. The method of claim 1, wherein actuation of the information key is configured to trigger display of context-sensitive help information to the user.

4. The method of claim 1, further comprising backlighting illumination of at least one key within the keypad in a first manner to indicate confirmation that actuation of the at least one key has been detected and in a second manner to attract attention to the at least one key.

5. The method of claim 1, wherein the numerical keys are configured to indicate selection of one of a product available for vending and a menu alternative displayed on the user interface display.

6. The method of claim 5, further comprising:
in response to actuation of the cancel key, removing a current product selection from a shopping cart for a current vend transaction; and
in response to actuation of the confirm key, adding the current product selection into the shopping cart for the current vend transaction.

7. The method of claim 6, wherein the cancel key is disposed on the left of the keypad and the confirm key is disposed on the right of the keypad.

8. A vending machine, comprising:
an enclosure configured to store a plurality of products;
a non-touchscreen user interface display configured to display a menu relating to vending of at least some of the plurality of products; and
a user selection interface configured to receive inputs from a customer, the user selection interface comprising a keypad configured to signal a customer key selection of one or more of a plurality of keys within the keypad, wherein the keypad includes a plurality of numeric keys, a cancel key, a confirm key, and at least one of
an information key that, when actuated, requests either additional information regarding a selected product or assistance in completing a vending transaction, and
a shopping cart key that, when actuated, either enables selection of an additional product for a multi-vend transaction or accepts a promotional offer.

9. The vending machine of claim 8, wherein actuation of the shopping cart key is configured to trigger utilization of shopping cart functionality within transaction flow programming and to allow the customer to aggregate multiple product selections for a single vend transaction.

10. The vending machine of claim 8, wherein actuation of the information key is configured to trigger display of context-sensitive help information to the user.

11. The vending machine of claim 8, wherein the user selection interface is configured to backlight illuminate at least one key within the keypad in a first manner to indicate confirmation that actuation of the at least one key has been detected and in a second manner to attract attention to the at least one key.

12. The vending machine of claim 8, wherein the numerical keys are configured to indicate selection of one of a product available for vending and a menu alternative displayed on the user interface display.

13. The vending machine of claim 12, wherein the vending machine is configured
in response to actuation of the cancel key, to remove a current product selection from a shopping cart for a current vend transaction, and
in response to actuation of the confirm key, to add the current product selection into the shopping cart for the current vend transaction.

14. The vending machine of claim 13, wherein the cancel key is disposed on the left of the keypad and the confirm key is disposed on the right of the keypad.

15. A keypad for use with a vending machine, comprising:
a plurality of keys configured to be actuated to receive inputs from a customer indicating a customer selection, the plurality of keys including a plurality of numeric keys, a cancel key, a confirm key, and at least one of
an information key that, when actuated, requests either additional information regarding a selected product or assistance in completing a vending transaction, and
a shopping cart key that, when actuated, either enables selection of an additional product for a multi-vend transaction or accepts a promotional offer.

16. The keypad of claim 15, wherein actuation of the shopping cart key is configured to trigger utilization of shopping cart functionality within transaction flow programming and to allow the customer to aggregate multiple product selections for a single vend transaction.

17. The keypad of claim 15, wherein actuation of the information key is configured to trigger display of context-sensitive help information to the user.

18. The keypad of claim 15, further comprising:
backlighting illumination for each of the plurality of keys, the backlighting illumination configured to illuminate at least one key within the keypad in a first manner to indicate confirmation that actuation of the at least one key has been detected and in a second manner to attract attention to the at least one key.

19. The keypad of claim 15, wherein the numerical keys are configured to indicate selection of one of a product available for vending and a menu alternative displayed on the user interface display.

20. The keypad of claim 15, wherein the keypad comprises a plurality of keys, each key defined by a delineated region on a smooth, continuous surface.
